(19) United States
(12) Patent Application Publication
(10) Pub. No.: US 2008/0072313 A1
(43) Pub. Date: Mar. 20, 2008

(54) Method of Establishing Security Permissions

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,545

(22) PCT Filed: Sep. 28, 2005
(86) PCT No.: PCT/IB05/53198

§ 371 Date: Apr. 3, 2007

(30) Foreign Application Priority Data
Oct. 5, 2004 (EP) 04104878.6

(51) Int. Cl. G06F 21/00

(52) U.S. Cl. 726/17

(57) ABSTRACT

A communication network (10) comprising devices (30, 40, 50, 60, 70, 80, 100, 120, 200) coupled together is described. The network (10) comprises: (a) a first device optionally having associated therewith user operable controls; (b) a second device having associated therewith user operable controls. In response to user input at said user operable controls of said second device, the second device buffers during a limited time period signed unauthorized instructions received thereat. The first device sends when activated during said time period signed instructions for receipt at the second device. The second device analyses the signed unauthorized instructions accumulated during the time period to determine whether or not the instructions originate from a single source and to authenticate the source. The second device assists with issuing a permission for enabling the first device corresponding to the identified source when all buffered signed instructions received during the limited time period originate from the authenticated source.

The present invention relates to methods of establishing security permissions, for example to a method of establishing security permissions in devices provided with user interfaces of limited scope. Moreover, the invention also relates to devices operable according to the method.

Electronic devices including computing hardware are increasingly being coupled together to form networks, for example locally within buildings (LANs) as well as internationally as networks (WANs) such as the Internet. Such networked devices are capable of providing greater functionality to their users; however, networking also renders the devices vulnerable to disruption, for example to hostile attack from software viruses as well as from third parties desirous of gaining access to private or privileged information of commercial value.

For example, any home computer connected to the Internet is vulnerable to attack. Contemporarily, a broadband Internet connection to a home computer will often convey probes predatory to an attack at intervals of a few minutes. Vulnerability to attack is becoming an increasingly relevant problem in the case of the future home where there is not only one personal computer connected to the Internet but also a local network including many computing devices. These future networks are potentially more vulnerable to attack in comparison to present personal computers individually coupled to the Internet.

There is therefore a growing awareness for network security. Security involves several elements as provided in Table 1:

TABLE 1

| | |
|---|---|
| data origin authentication | command authorization |
| message integrity protection | message replay prevention |
| data confidentiality | key distribution |

In order to authenticate a message communicated in a network, the message's source needs to be established. A conventional approach to establish source identity is to use cryptography, for example private-public key cryptography. Command authorization establishes whether or not a command involving a party X invoking an operation Y is permitted and should be executed. Such command authorization requires both authorization and authentication to be determined before the command can be executed.

Contemporary UPnP Security™ provides a security architecture in which a device enforces its own access control but its access control policy is established and maintained by an administrative application often referred to as a “Security Console”. In UPnP Security, nothing prevents a device equipped with proper user interface capabilities from providing its own administration interface. Thus, the term “Security Console” effectively refers to any control point that chooses to exercise administrative functions as will be elucidated later.

Various approaches to enhancing network security are known. For example, in a published United States patent application no. US2003/0056114, there is described a scheme for networked device branding for secure interactions in trust webs on open networks. The scheme employs a branding process providing a networked computing device with initial set-up information, including a name, a public/private key pair, and a set of certificates the device will need to inter-operate with other devices in the trust group. A branding device conveys the initial set-up information to the networked computing device via a limited access network interface, or alternatively via a broadcast network medium with the device enclosed in a wave guide and/or Faraday cage; the networked computing device is thereby provided with trusted information. The networked computing device can then use the set-up information to verify that other devices coupled to the network that seek to interact with the networked computing device and also members of the trust group with which the networked computing device are capable of interacting.

When networks are complex and include many devices and no limited access network interface and/or Faraday cage is available, it is often a difficult task for users to set various degrees of security for the devices, namely setting device permissions is potentially a major data entry exercise. Such data entry is especially difficult when executed from network devices provided with relatively limited user interfaces.

An object of the present invention is to provide a method of establishing security provisions in a communication network using a device with limited user interface.

According to a first aspect of the present invention, there is provided a method of establishing security permissions in a communication network comprising a plurality of devices coupled together for mutually communicating there between, said method comprising steps of:
(a) arranging for the plurality of devices to comprise at least a first device and a second device, said second device having associated therewith one or more user operable controls, said first device optionally having associated therewith one or more user operable controls;
(b) in response to user input at said one or more user operable controls of said second device, arranging for the second device to be operable during a limited time period to buffer signed unauthorized instructions received thereat via the network;
(c) during said time period, activating the first device, said activation optionally using said one or more user operable controls at the first device, to send one or more signed instructions via the network for receipt at the second device;
(d) at the second device, analyzing the one or more buffered signed unauthorized instructions accumulated during the time period to determine whether or not the one or more instructions originate from a single source and to authenticate the source; and
(e) arranging for the second device to assist in issuing a permission for enabling the first device corresponding to the identified source when all buffered signed instructions received during the limited time period originate from the authenticated source.

The invention is of advantage in that it is capable of making it easier to establish permissions in communication networks.

Optionally, the method includes a further step of executing instructions delayed during the limited time period after expiration of the time period. This further step is of benefit of reducing disruption to the network when a new device is granted permission within the network.

Optionally, in step (b) of the method, the second device is operable to buffer the signed instructions received thereat for a predefined period. More optionally, the period corresponds to substantially 10 seconds, and not more than 30 seconds. Such a duration for the period is found in practice to be convenient especially for relatively smaller networks, for example domestic or office networks, where direct human intervention is involved when configuring the network. Optionally, the period can be made dependent on a second user signal, for example a user releasing a depressed button that was pressed to initiate the limited period on the second device, or the user pressing a second button or issues a voice command to end the limited period. Moreover, the first device can be beneficially arranged to indicate with a light and/or audio beep when one or more signed unauthorized commands have been received at the second device for indicating that the user need no longer depress the button associated with the first device.

Optionally, in the method, the network is arranged to function according to the UPnP protocol standard wherein permissions granted by the control point to devices in the network are added to an Access Control List (ACL) accessible to devices of the network. Implementing the method within a UPnP framework is of benefit in that it renders the method readily useable in existing contemporary communication networks.

More optionally, in the method, signed unauthorized requests received from a plurality of sources in the network during said time period cause the second device to refrain from issuing permissions and not to update the Access Control List. This check for a plurality of sources renders it more difficult for hostile parties to intervene when the network is under reconfiguration to alter network permissions.

Optionally, in the method, signed unauthorized requests received during said time period remain unexecuted within the network.

Optionally, in the method, the second device is operable to employ an encryption key for updating a record of permissible device access within the network. Use of this encryption key is susceptible to making the network less vulnerable to corruption when being reconfigured with new permissions.

Optionally, the method includes a further step of revoking a most recently granted permission granted by the second device in response to the user activating one or more of the controls associated with the first device on identifying incorrect operation of the network. Such revocation is of benefit in that it allows the user to reconfigure the network rapidly in the event of a third party having influenced the allocation of new permissions.

Optionally, in the method, one or more unauthorized instructions correspond to specific functions selected by the user for the first device during said time period, wherein said permission granted by the first device relate to implementing said specific selected functions.

According to a second aspect of the invention, there is provided a communication network comprising a plurality of devices coupled together for mutually communicating there between, the network comprising:
(a) a first device optionally having associated therewith one or more user operable controls;
(b) a second device having associated therewith one or more user operable controls; wherein:
(c) in response to user input at said one or more user operable controls of said second device, the second device is operable during a limited time period to buffer signed unauthorized instructions received thereat via the network;
(d) the first device is operable when activated during said time period, said activation optionally using said one or more user operable controls at the first device, to send one or more signed instructions via the network for receipt at the second device;
(e) the second device is operable to analyze the one or more buffered signed unauthorized instructions accumulated during the time period to determine whether or not the one or more instructions originate from a single source and to authenticate the source; and
(f) the second device is operable to assist in issuing a permission for enabling the first device corresponding to the identified source when all buffered signed instructions received during the limited time period originate from the authenticated source.

Optionally, in the network, the second device is operable to buffer the one or more signed instructions received thereat for a period of substantially 10 seconds, and not more than 30 seconds.

Optionally, the network is arranged to function according to the UPnP protocol standard wherein permissions granted to devices in the network are added to Access Control Lists (ACL) of the devices.

Optionally, in the network, the network is operable to refrain from issuing permissions and not to update the Access Control List when signed unauthorized requests are received at the second device during said time period from a plurality of sources within the network.

Optionally, in the network, an encryption key is employed for updating a record of permissible device access within the network.

Optionally, in the network, the network includes means for revoking a most recently granted permission granted in response to the user activating one or more of the controls on identifying incorrect operation of the network.

Optionally, in the network, the one or more unauthorized instructions correspond to specific functions selected by the user on the first device during said time period, and the second device is operable to assist granting permission relating to said specific selected functions.

According to a third aspect of the invention, there is provided a network device for implementing a method according to the first aspect of the invention.

According to a fourth aspect of the invention, there is provided a network device for assisting in granting device permissions in a network according to the second aspect of the invention.

It will be appreciated that features of the invention are susceptible to being combined in any combination without departing from the scope of the invention.

Embodiments of the invention will now be described, by way of example only, with reference to the following diagrams wherein:

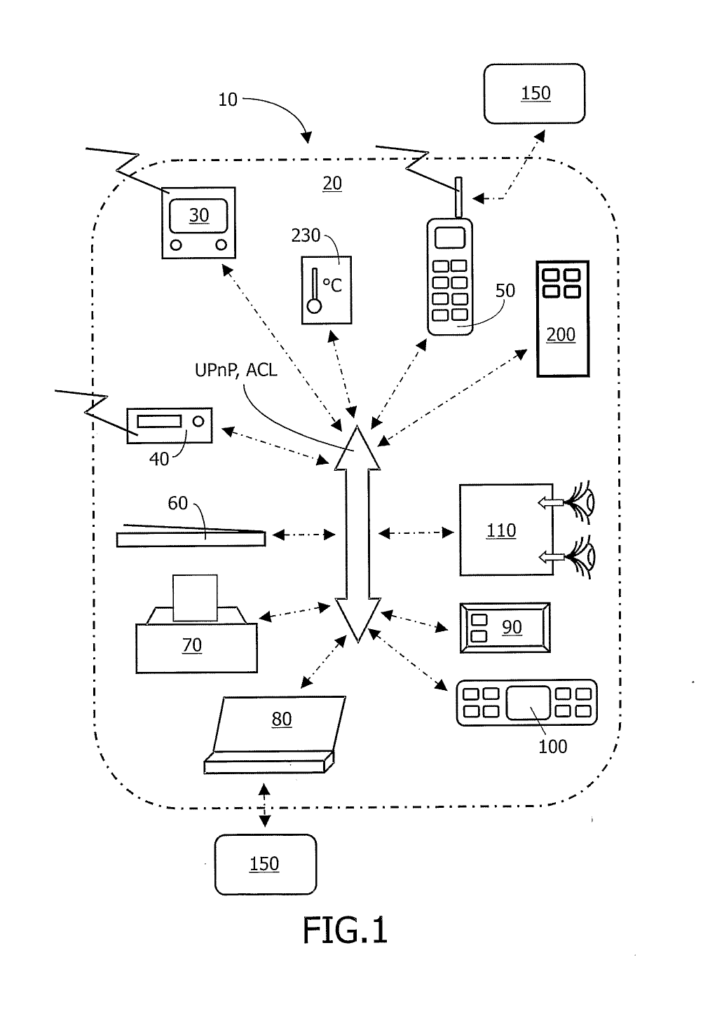

FIG. 1 is a schematic diagram of a network according to the invention;

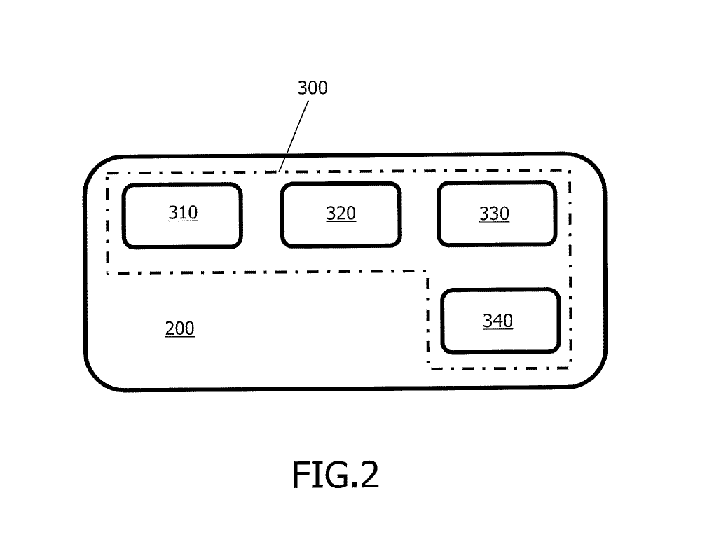

FIG. 2 is a schematic illustration of controls of a control point forming a part of the network illustrated in FIG. 1; and

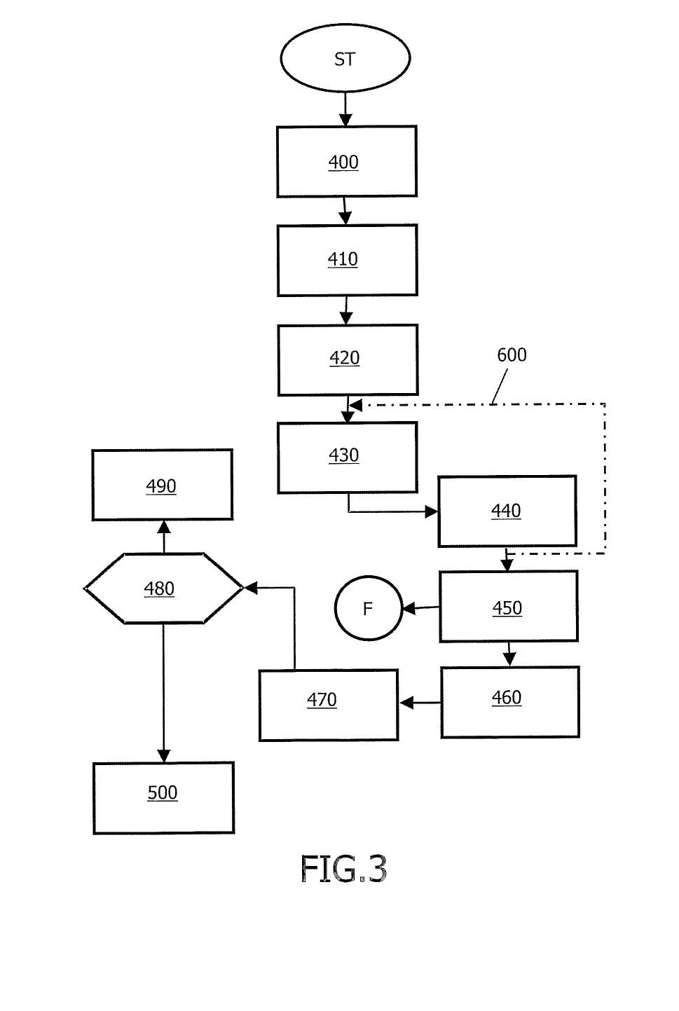

FIG. 3 is a schematic flow chart of steps executable to implement the present invention.

Contemporary communications networks comprise several devices coupled together, the devices being mutually spatially distributed. For example, in FIG. 1 there is shown a network indicated generally by 10 comprising an assembly of electronic devices in domestic premises 20, such devices including for example one or more of a smart television 30, a video recorder 40, a telephone 50, a scanner 60, a printer 70 a personal computer (PC) 80, a pager 90, a handheld computer 100, an intruder alarm system 110 and a central heating controller 120. One or more of the devices in the network 10 are optionally coupled to an external communication network 150, for example the Internet via one or more of a wireless link, an optical link and a radio link. The devices within the network 10 are mutually coupled for communication purposes using wired connections and/or short-distance wireless connection.

The network 10 is preferably arranged to operate according to established standards, namely protocols, such as the aforementioned UPnP standard described in UPnP Device Architecture 1.0, of June 2000, and in UPnP Security Console 1.0 and UPnP Device Security 1.0, both of November 2003 issued by the UPnP Implementers Corporation; implementation of this standard is hereby incorporated by reference for purposes of describing embodiments of the present invention. The inventor has appreciated that a given device in the network 10 operating according to the UPnP Architecture needs to obtain a set of permissions before it is authorized to invoke actions on one or more other devices within the network 10, for example the telephone 50 instructing the video recorder 40 to record a particular preferred television program, the central heating controller 120 to increase room temperature within the premises 20, and the intruder alarm system 110 to be deactivated.

In overview, the network 10 is capable of being arranged to comprise a first device operable a control point, a second device operable as a security console, and a third device operable to receive and implement instructions. The first device functioning as a control point requires permissions to instruct devices within the network 10. Moreover, the second device functioning as a security console issues permissions to control points, for example the first device. Furthermore, the third device is operable to accept instructions from control points provided that permissions are stored in its Access Control List (ACL). Optionally, a UPnP device of the network 10 can be provided with a UPnP security console function embedded therein, for example integrated within one physical box or enclosure; such an arrangement corresponds to spatially collocating the aforementioned first and second devices. As will be elucidated later, the box or enclosure can be provided with a relative limited set of controls.

Thus, a given device 200 in the network 10 can, for example, function as a security console; this device 200 will hereafter be referred to as the security console 200. When the security console 200 has a relatively limited user interface, it is potentially difficult for users to input data thereto for instructing the security console 200 so that various permissions are issued to various devices in the network 10 or to the device 200 itself for determining their scope for instructing or controlling other devices or being controlled by other devices within the network 10. As illustrated in FIG. 2, the security console 200 is equipped with three buttons 300 for use in connection with permissions being issued. For example, the security console 200 is preferably arranged so that the buttons 300 comprise a guest button 310, a full permission button 320 and a limited-time guest button 330. The limited time preferably corresponds to substantially in a range of 1 to 10 hours, and most preferably substantially 4 hours.

A method of operating the security console 200 will now be described with reference to FIG. 2.

STEP 1: With the network 10 in operation, a user of the security console 200 presses the guest button 330 causing the security console 200 to cause another device of the network 10, namely a device X, to buffer into its memory all incoming signed unauthorized requests for action received thereat. Such accumulation of incoming signed unauthorized requests can be implemented for a time period whilst the button 330 of the security console 200 is depressed, or for a predefined period, for example up to substantially 10 seconds after the button 330 is depressed. Optionally, the predefined period is not more than substantially 30 seconds.

STEP 2: At the end of the time period, or when the user releases the button 330 as appropriate, the other device X then analyses the signed unauthorized requests stored in its memory. When the analysis identifies that signed unauthorized requests have been received at the other device X consistently from only one source, the device X assumes the source to be an device Y of the network 10: conveniently, the device Y is known as a control point. Such analysis, when one source is identified, the device X to add the device Y to the Access Control List (ACL) of the device X with a permission that matches the pressed button on the security console 200. Optionally, one or more previous permissions stored are revoked when the ACL is updated.

When executing the aforementioned method, in an event that the device X during the period of buffering incoming messages thereto receives requests from several other control points, for example other devices, coupled into the network 10, none of them receives authorization, namely permissions are not issued and the ACL of the device X is not updated. Such a restriction when messages are received from several other devices or control points potentially avoids accidentally issuing permissions to a wrong control point or device.

Operation of the security console 200 described in the foregoing provides a method of giving detailed permissions to individual control points or devices with a minimum of user interface. The method conforms to existing standards, for example contemporary UPnP protocol, and the control points are capable of performing their functions by executing normal standard instructions, for example UPnP instructions.

When the method is implemented using UPnP instructions, a SetSessionKey action is invoked prior to secure action being taken, and is signed using a public key of the device Y, namely the control point (CP). By issuing such a public-key secured action, the device Y has all necessary information required for updating the ACL governing operation of the network 10.

It is to be appreciated in the foregoing that the security console 200, the device X and the device Y are described as being individual devices within the network 10. Various arrangements for implementing the present invention in the network 10 are possible. For example, if required, one of more of the devices of the network can be spatially collocated, for example the security console 200 and the device Y can be physically collocated together in one physical housing. For example, the device X can function as a UPnP device, the device Y can function as a UPnP security console, and controls W can be associated with a device Z. Thus, in operation, the user presses the controls W causing the UPnP device X to buffer incoming signed unauthorized requests thereat. After timeout or release of the controls W, the device X's ACL is not updated if more than one source of incoming signed unauthorized requests to the device X is identified. Alternatively, if only one source of signed unauthorized requests is identified by the device X, device Y functioning as a security console is capable of updating the ACL of the UPNP device X.

Operation of the network 10 will be further described with reference to FIG. 3. In FIG. 3, there is shown a flow chart whose steps ST, 400 to 500 of a method as defined in Table 2. The steps of the method are executed in a sequence as indicated by arrows in FIG. 3.

TABLE 2

| Step | Description |
|---|---|
| ST | Start method |
| 400 | User presses “give permission” button of the controls W on the device Z |
| 410 | UPnP device X starts buffering incoming signed unauthorized action-requests |
| | received thereat |
| 420 | User uses UI of another device A in the network 10 and prompts the device A to |
| | send one or more signed action requests to the UPnP device X |
| 430 | On receiving the one or more signed unauthorized action requests from the device |
| | A, the UPnP device X buffers these one or more requests |
| 440 | Optionally, the device Z signals to the user that one or more requests have been |
| | received at the UPnP device X |
| 450 | Optionally, the device Z on receiving and buffering actions from a plurality of |
| | devices in the network indicates failure “F” to the user |
| 460 | User releases “give permission” button on the controls W or the device Z times- |
| | out |
| 470 | The UPnP device X checks in its buffered action requests that it has signed request |
| | from a single device in the network 10 |
| 480 | If in step 470 the action requests are only from a single device, the method |
| | progresses to step 490, otherwise the method proceeds to step 500 |
| 490 | The security console Y issues a permission to the UPnP device X |
| 500 | The device Z indicates failure to the user |

Steps 440, 450 are optional and, if required, can be omitted in the procedure. Moreover, the procedure optionally repeats steps 430, 440 as denoted by a dashed arrow 600.

It will be appreciated that embodiments of the invention described in the foregoing are susceptible to being modified without departing from the scope of the invention as defined by the accompanying claims.

The network 10 including the security console 200 operable according to the aforesaid method is potentially open to attack when the security console 200 is about to invoke a secured action. An attacking party is potentially capable of blocking the security console 200 and issuing the secured action instead. In consequence, an incorrect permission is issued, for example, to the attacking party. In such a situation, it will rapidly be appreciated by the user that the security console 200 is not working as intended. Therefore, in order to cope with this situation, the security console 200 is preferably provided with an additional button 340 for revoking a most recently granted permission. If required, the revoking function provided by the button 340 can be implemented using one or more of the three other buttons 310, 320, 330, for example the function of the button 340 being implemented using one of the other buttons 310, 320, 330 held down again for a short time interval, thereby keeping the interface presented to the user at the security console 200 as simple as possible.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1. A method of establishing security permissions in a communication network (10) comprising a plurality of devices (30, 40, 50, 60, 70, 80, 90, 100, 110, 200) coupled together for mutually communicating there between, said method comprising steps of:
(a) arranging for the plurality of devices (30, 40, 50, 60, 70, 80, 90, 100, 110, 200) to comprise at least a first device (30, 40, 50, 60, 70, 80, 90, 100, 110) and a second device (200), said second device (200) having associated therewith one or more user operable controls (300), said first device (30, 40, 50, 60, 70, 80, 90, 100, 110) optionally having associated therewith one or more user operable controls;
(b) in response to user input at said one or more user operable controls (300) of said second device (200), arranging for the second device (200) to be operable during a limited time period to buffer signed unauthorized instructions received thereat via the network (10);
(c) during said time period, activating the first device (30, 40, 50, 60, 70, 80, 90, 100, 110, 200), said activation optionally using said one or more user operable controls at the first device, to send one or more signed instructions via the network (10) for receipt at the second device (200);
(d) at the second device (200), analyzing the one or more buffered signed unauthorized instructions accumulated during the time period to determine whether or not the one or more instructions originate from a single source and to authenticate the source; and
(e) arranging for the second device (200) to assist with issuing a permission for enabling the first device (30, 40, 50, 60, 70, 80, 90, 100, 110) corresponding to the identified source when all buffered signed instructions received during the limited time period originate from the authenticated source.

2. A method according to claim 1 including a further step of executing instructions delayed during the limited time period after expiration of the time period.

3. A method according to claim 1, wherein, in step (b), the second device is operable to buffer the signed instructions received thereat for a predefined period.

4. A method according to claim 3, wherein the period corresponds to substantially 10 seconds, and not more than 30 seconds.

5. A method according to claim 1, wherein the network (10) is arranged to function according to the UPnP protocol standard wherein permissions granted to devices in the network (10) are added to an Access Control List (ACL) accessible to devices of the network (10).

6. A method according to claim 5, wherein signed unauthorized requests received from a plurality of sources in the network (10) during said time period cause the second device to refrain from issuing permissions and not to update the Access Control List.

7. A method according to claim 3, wherein signed unauthorized requests received at the second device (200) during said time period remain unexecuted within the network (10).

8. A method according to claim 1, wherein the second device is operable to employ an encryption key for updating permissible device access within the network (10).

9. A method according to claim 1, including a further step of revoking a most recently granted permission granted by the second device in response to the user activating one or more of the controls associated with the first device (200) on identifying incorrect operation of the network (10).

10. A method according to claim 1, wherein the one or more unauthorized instructions correspond to specific functions selected by the user on the device during said time period, wherein said permission granted by the second device relate to implementing said specific selected functions.

11. A communication network (10) comprising a plurality of devices (30, 40, 50, 60, 70, 80, 90, 100, 110, 200) coupled together for mutually communicating there between, the network (10) comprising:
(a) a first device (30, 40, 50, 60, 70, 80, 90, 100, 1120) optionally having associated therewith one or more user operable controls;
(b) a second device (200) having associated therewith one or more user operable controls (300); wherein:
(c) in response to user input at said one or more user operable controls (300) of said second device (200), the second device (200) is operable during a limited time period to buffer signed unauthorized instructions received thereat via the network (10);
(d) the first device (30, 40, 50, 60, 70, 80, 90, 100, 110) is operable when activated during said time period, said activation optionally using said one or more user operable controls at the first device (30, 40, 50, 60, 70, 80, 90, 100, 110), to send one or more signed instructions via the network (10) for receipt at the second device (200);
(e) the second device (200) is operable to analyze the one or more buffered signed unauthorized instructions accumulated during the time period to determine whether or not the one or more instructions originate from a single source and to authenticate the source; and
(f) the second device (200) is operable to assist with issuing a permission for enabling the first device (30, 40, 50, 60, 70, 80, 90, 100, 110) corresponding to the identified source when all buffered signed instructions received during the limited time period originate from the authenticated source.

12. A network (10) according to claim 11, wherein the second device (200) is operable to buffer the one or more unauthorized instructions received thereat for a period of substantially 10 seconds, and not more than 30 seconds.

13. A network (10) according to claim 11 arranged to function according to the UPnP protocol standard wherein permissions granted to devices in the network (10) are added to an Access Control Lists (ACL) of the devices.

14. A network (10) according to claim 13, wherein the network (10) is operable to refrain from issuing permissions and not to update the Access Control List when signed unauthorized requests are received at the second device (200) during said time period from a plurality of sources within the network (10).

15. A network (10) according to claim 11, said network (10) being arranged to employ an encryption key for updating a record of permissible device access within the network (10).

16. A network (10) according to claim 11, wherein the network (10) includes means for revoking a most recently granted permission granted in response to the user activating one or more of the controls on identifying incorrect operation of the network (10).

17. A network (10) according to claim 11, wherein the one or more signed unauthorized instructions correspond to specific functions selected by the user during said time period, and the second device is operable to assist granting permission relating to said specific selected functions.

18. A network device (200) for implementing a method according to claim 1.

19. A network device (200) for assisting in granting device permissions in a network (10) according to claim 10.
